(19) United States
(12) Patent Application Publication
(10) Pub. No.: US 2013/0161458 A1
(43) Pub. Date: Jun. 27, 2013

(54) DASHBOARD BRACKET FOR VEHICLE

(71) Applicant: Beat-Sonic Co., Ltd., Nisshin-shi (JP)

(72) Inventors: Tsutomu TOTANI, Nisshin-shi (JP); Yuichi HORIUCHI, Nisshin-shi (JP)

(73) Assignee: BEAT-SONIC CO., LTD., Nisshin-shi (JP)

(21) Appl. No.: 13/749,772

(22) Filed: Jan. 25, 2013

(30) Foreign Application Priority Data
Dec. 26, 2011 (JP) 2011-282802
Feb. 16, 2012 (JP) 2012-031302

(51) Int. Cl. B60R 11/02

(52) U.S. Cl. CPC B60R 11/0205
USPC 248/205.1

(57) ABSTRACT

A dashboard bracket for a vehicle includes a front panel and insertion plates located on right and left or upper and lower ends of the front panel. The bracket has a width and a height set according to a width and a height of a first accommodating recess for installation of a car audio device so that the right and left insertion plates are secured to right and left wall surfaces of the first accommodating recess or so that the upper and lower insertion plates are secured to upper and left wall surfaces of the first accommodating recess, respectively. The first accommodating recess is defined in a vehicle dashboard and has standardized width and height. The front panel has an opening and a second accommodating recess is defined by the recess defining member for accommodation of nongenuine equipment so as to be located behind the front panel opening.

### CROSS-REFERENCE TO RELATED APPLICATIONS

This application is based upon and claims the benefit of priority from the prior Japanese Patent Application No. 2012-031302 filed on Feb. 16, 2012, the entire contents of which are incorporated herein by reference.

### BACKGROUND

1. Technical Field

The present disclosure relates to a dashboard bracket for a vehicle and more particularly to such a dashboard bracket mounted in an accommodating recess which is provided in a dashboard for accommodation of a car audio.

2. Related Art

There have recently been provided in markets high-performance portable music players which are small in size and are capable of storing a large volume of footage and music or highly operable information terminal devices using a mobile telephone network. A large number of users desire to use a latest portable music player or a latest highly operable information terminal device, instead of a genuine car audio device installed in his/her vehicle. Furthermore, the users desire to use a higher performance nongenuine car audio system, instead of a genuine car audio system.

In order that a portable music player may be used in a vehicle interior during drive, a dedicated holder is usually used to fix the portable music player to an upper surface of the dashboard or a center console. However, this type of holder needs to be mounted so as not to block driver's view or blast of air from a car air conditioner, or so as not to disturb operation of operation buttons of the car air conditioner or manipulation of a shift lever. This limits an installation place of the holder. Furthermore, the mounted holder sometimes degrades the showing of the dashboard or the center console. An installation place of a nongenuine car audio system is also limited when replaced with the genuine car audio system.

### SUMMARY

An object of the disclosure is therefore to provide a dashboard holder for a vehicle, which can be used to install nongenuine equipment such as a portable music player, a highly operable information terminal device using the mobile telephone network or a nongenuine car audio system, without blocking driver's view and air blast from a car air conditioner, disturbing operation of operation buttons of the car air conditioner and manipulation of the shift lever and degrading the showing of the dashboard or the center console.

The present disclosure provides a dashboard bracket for a vehicle, comprising a front panel and a plurality of insertion plates located on right and left ends of the front panel or upper and lower ends of the front panel, the bracket having a width and a height set according to a width and a height of a first accommodating recess for installation of a car audio device so that the right and left insertion plates are secured to right and left wall surfaces of the first accommodating recess or so that the upper and lower insertion plates are secured to upper and left wall surfaces of the first accommodating recess, respectively, the first accommodating recess being defined in a dashboard of the vehicle and having a standardized width and a standardized height, wherein the front panel is formed with an opening and a second accommodating recess is defined by a recess defining member for accommodation of nongenuine equipment so as to be located behind the opening of the front panel.

Almost all passenger vehicles employ dashboards formed with car audio equipment accommodating recesses having sizes complying with a single DIN or double DIN size of the German Industry Standard (Deutsch Industrie Norman (DIN)) 75490 (ISO 7736). An accommodating recess complying with the single DIN size has a width of 180 mm and a height of 50 mm and an accommodating recess complying with the double DIN size has a width of 160 mm and a height of 100 mm. The invention claimed in claim 1 was made while focused on this respect.

Thus, the above-described bracket has the width and the height which are set according to the width and the height of the first accommodating recess formed in compliance with the single DIN or double DIN standard size. Consequently, the bracket can be mounted in the accommodating recess from which the genuine car audio device has been removed.

The first accommodating recess having the standard size is originally disposed so that driver's view and blast of air from a car air conditioner can be prevented from being blocked by a genuine car audio device which is to be mounted in the first accommodating recess. Accordingly, even when the dashboard bracket is mounted in the accommodating recess, the dashboard bracket does not result in inexpedience that driver's view and air blast from the car air conditioner are blocked by the bracket.

Furthermore, since the first accommodating recess is provided with screw holes and/or positioning protrusions for the purpose of mounting the genuine car audio in the accommodating recess, the dashboard bracket can be mounted in the accommodating recess by using the screw holes and/or the positioning protrusions without machining or modifying the dashboard.

In the above-described invention, the front panel is formed with an opening and provided with a second accommodating recess which is defined behind the opening to accommodate a portable music player, an information terminal or nongenuine equipment such as a nongenuine car audio device. As a result, the portable music player, an information terminal device or nongenuine equipment such as a nongenuine car audio device can be housed in the second accommodating recess. This can prevent the showing of the dashboard from being degraded by the nongenuine equipment.

In one embodiment, the width and the height of the front panel are set so that a front opening of the first accommodating recess is substantially covered by the front panel. Since the front opening of the first accommodating recess is covered by the front panel, the front opening is prevented from being exposed and the showing of the dashboard can be prevented from being degraded even when the car audio has been removed from the first accommodating recess.

In another embodiment, the bracket further comprises a joint fixed to a front surface of the front panel. The joint has an end to which a holder holding a portable music player or an information terminal device is detachably attachable. The joint is capable or adjusting a direction of the holder in an up-down direction or a right-left direction. According to this, not only the nongenuine equipment such as the portable music player can be housed in the second accommodating recess, but also the portable music player or the information/communication terminal can be mounted on the front surface of the front panel. Furthermore, since the direction of the nongenuine equipment is adjustable, the usability of the bracket can be improved.

### BRIEF DESCRIPTION OF THE DRAWINGS

In the accompanying drawings:

FIG. 1 illustrates a dashboard provided with an accommodating recess complying with the double DIN size and housing a genuine car audio device;

FIG. 2 illustrates the dashboard with the accommodating recess from which the car audio device has been detached;

FIG. 3 illustrates the dashboard having an accommodating recess of the double DIN size, in which the dashboard bracket for the vehicle is mounted in the accommodating recess;

FIG. 4 is a perspective view of the dashboard bracket according to the first embodiment;

FIG. 5 is a plan view of the dashboard bracket mounted in the accommodating recess;

FIG. 6 is a partially broken side view of the dashboard bracket;

FIG. 7 is a rear perspective view of a holder to be attached to a joint of the dashboard bracket;

FIG. 8 is a perspective view of the dashboard bracket according to a second embodiment;

FIG. 9 is a perspective view of the dashboard bracket according to a third embodiment;

FIG. 10 illustrates a dashboard provided with an accommodating recess complying with a single DIN size;

FIG. 11 illustrates the dashboard provided with the single DIN size accommodating recess from which a car audio device has been removed;

FIG. 12 illustrates a dashboard provided with the single DIN size accommodating recess in which the dashboard bracket according to a fourth embodiment is mounted;

FIG. 13 is a perspective view of the dashboard bracket according to the fourth embodiment;

FIG. 14 is a perspective view of the dashboard bracket according to a fifth embodiment;

FIG. 15 is a perspective view of the dashboard bracket according to a sixth embodiment;

FIG. 16 is a plan view of the dashboard bracket according to the sixth embodiment;

FIG. 17 is a plan view of a lock plate of the dashboard bracket according to the sixth embodiment;

FIG. 18 is a side view of the lock plate of the dashboard bracket according to the sixth embodiment;

FIG. 19 is a perspective view of the dashboard bracket according to a seventh embodiment;

FIG. 20 is a plan view of the dashboard bracket according to the seventh embodiment;

FIG. 21 is a plan view of the lock plate of the dashboard bracket according to the seventh embodiment; and

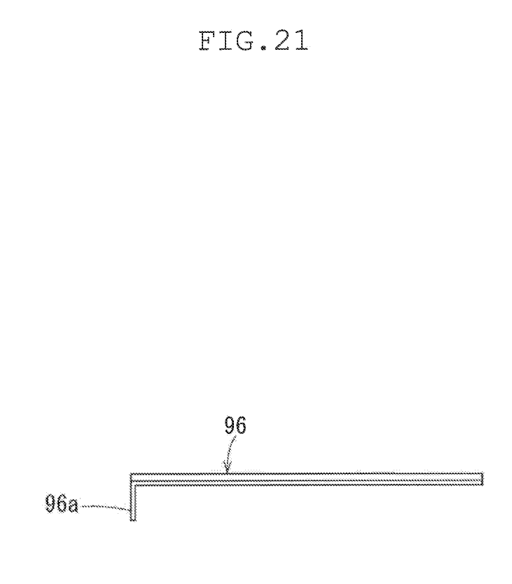

FIG. 22 is a side view of the lock plate of the dashboard bracket according to the seventh embodiment.

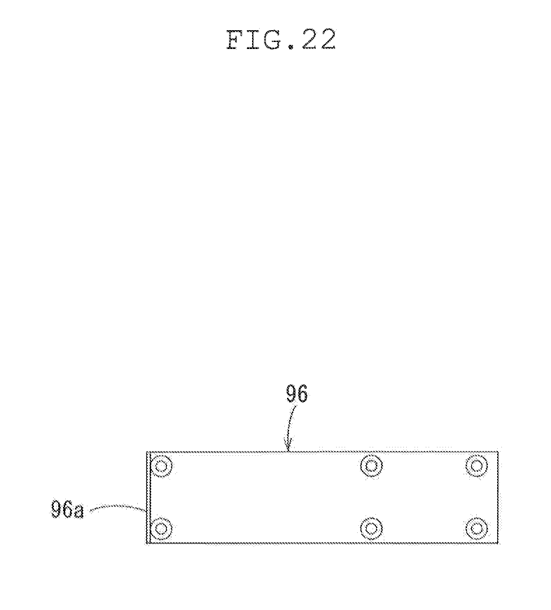

### DETAILED DESCRIPTION

Several embodiments will be described with reference to the accompanying drawings.

### First Embodiment

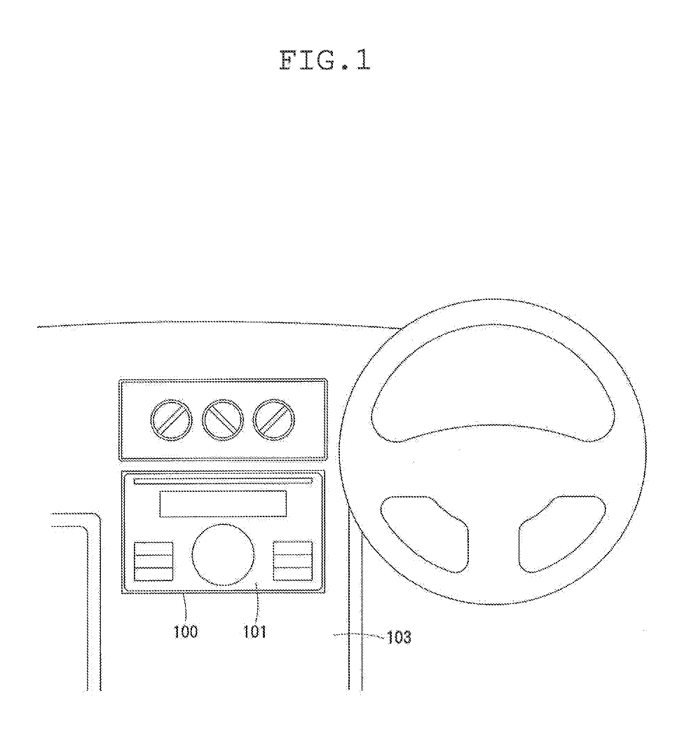

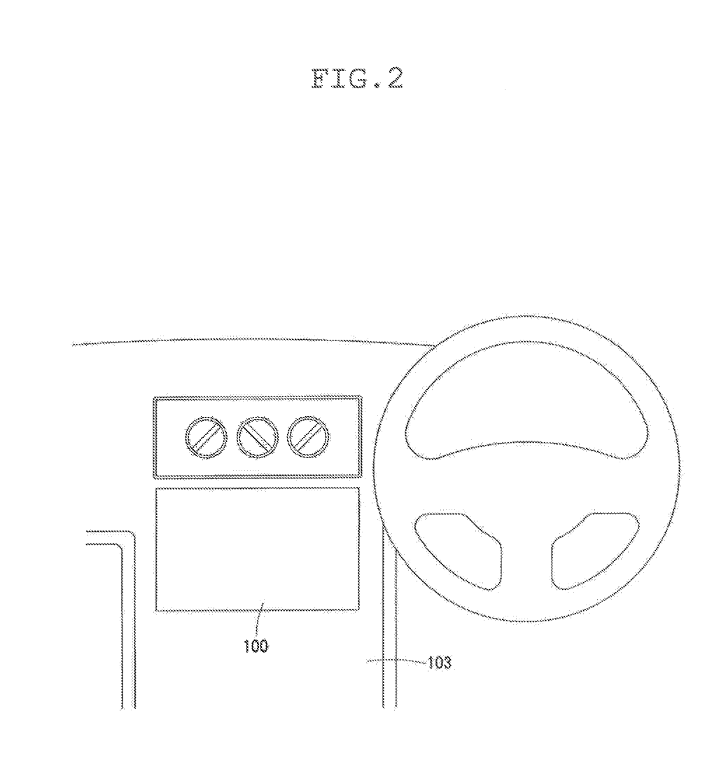

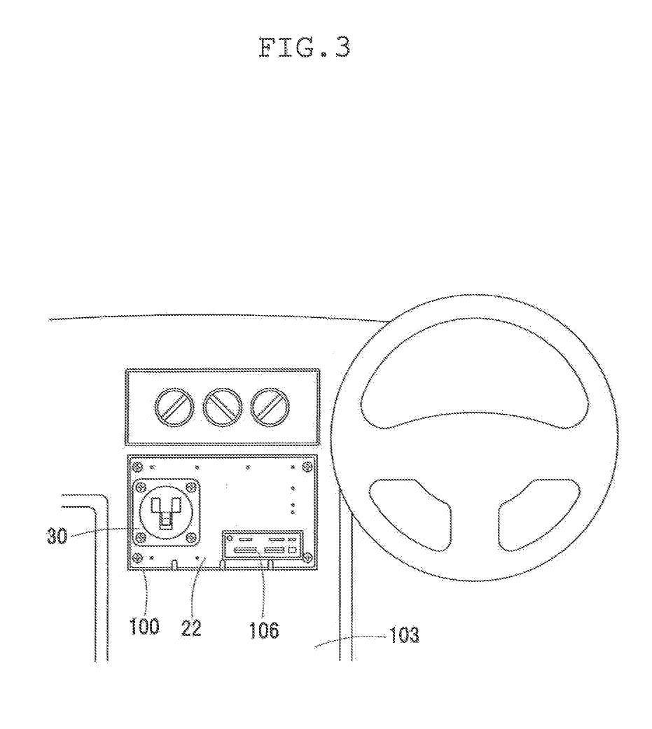

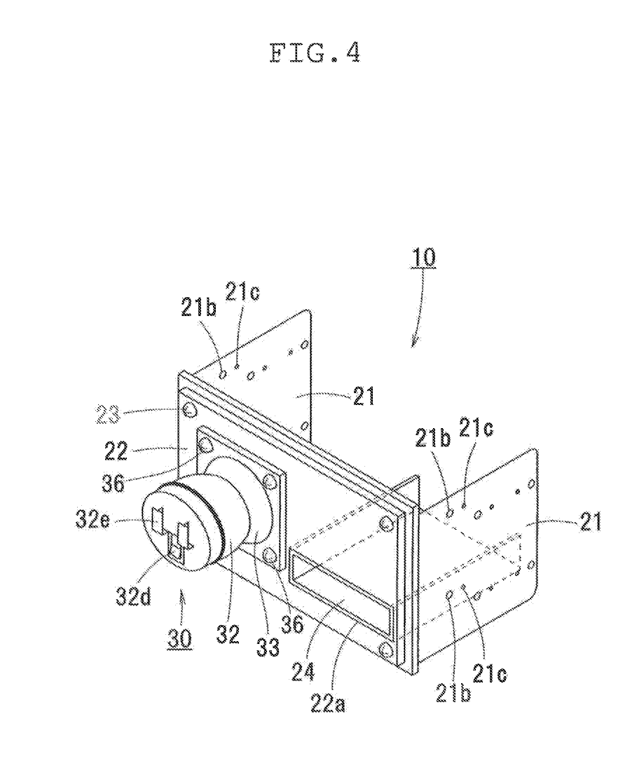

FIG. 1 shows a dashboard 103 of a vehicle having a genuine car audio device mounted in a car audio accommodating recess 100 complying with a double DIN size. FIG. 2 shows the dashboard 103 having the accommodating recess 100 from which the genuine car audio device has been removed. FIG. 3 shows the dashboard 103 having the double DIN size accommodating recess 100 in which a dashboard bracket 10 for a vehicle according to a first embodiment is mounted. FIGS. 4 to 6 illustrate the dashboard bracket 10 according to the first embodiment.

The dashboard bracket 10 includes two insertion plates 21 and a front panel 22 having right and left ends to which the insertion plates 21 are connected respectively so that the dashboard bracket 10 is generally formed into a C-shape. In more detail, the insertion plates 21 have respective ends which are located at the front panel 22 side and bent at a right angle into bent portions 21a. The bent portions 21a are fixed to rear surfaces of the right and left ends of the front panel 22 by small screws 23 respectively. Each insertion plate 21 has a plurality of screw holes 21b and a plurality of positioning small holes 21c paired with the screw holes 21b respectively. Six such pairs of screw holes 21b and positioning small holes 21c are formed in the embodiment.

The front panel 22 has a width and a height both of which are set so as to be capable of being housed in the double DIN size accommodating recess 100 and so as to cover a front opening 100a of the accommodating recess 100. The front panel 22 is formed with a horizontally long rectangular opening 22a. An accommodating recess 24 is provided behind the opening 22a. The accommodating recess 24 is defined by a recess defining member including right and left sides 24a and a bottom 24b and has a generally C-shaped section. The recess defining member has front and rear ends both of which are open. One of the right and lefts sides 24a is fixed by small screws 25 to a bent strip 21d which is formed integrally with the insertion plate 21. The other side 24a has a retainer strip 24c formed integrally therewith. The retainer strip 24c is caught by a catch strip 22b formed integrally with the rear of the front panel 22, whereby the other side 24a is caught on the front panel 22.

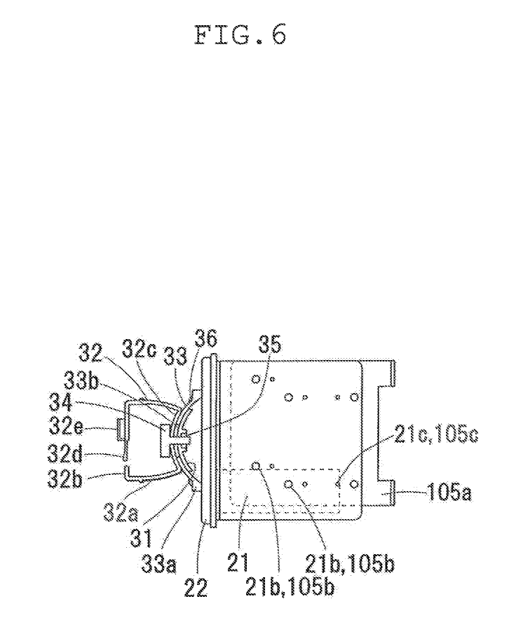

A joint 30 is fixed to the front surface of the front panel 22. The joint 30 includes an inner curved strip 31, an outer curved member 32, a guide strip 33, a bolt 34 and a nut 35, as shown in FIG. 6. The inner curved strip 31, the outer curved member 32 and the guide strip 33 are each formed of resin. The inner curved strip 31 has a curved surface composing a part of a spherical surface of a hollow sphere. The inner curved strip 31 has a through hole formed in a central inner side thereof and a hexagonal hole formed around the through hole. The nut 35 is fitted in the hexagonal hole.

The outer curved member 32 includes a cylindrical body 32a and a cover 32b. The cover 32b is screwed to the cylindrical body 32a. The cylindrical body 32a has a bottom 32c constituted by a curved surface composing a part of a spherical surface of a hollow sphere. The curved bottom 32c has a through hole formed therethrough. The cover 32b has a surface further having a lock protrusion 32d and two hook strips 32e each having a generally L-shaped section. The lock protrusion 32d and the hook strips 32e are formed integrally with the cover 32b. The lock protrusion 32d is formed between the hook strips 32e.

The guide strip 33 has a curved surface composing a part of a spherical surface of a hollow sphere and includes a flange 33a which is formed integrally therewith. The flange 33a is formed around the curved surface of the guide strip 33 and has a square outer shape. The guide strip 33 has a circular opening 33b formed in a central part of the curved surface. The curved surface of the guide strip 33 has a curvature radius that is set to be larger than that of the inner curved strip 31 and smaller than that of the curved bottom 32c of the outer curved member 32. The circular opening 33b of the guide strip 33 has a radius that is set to be smaller than a maximum outer diameter of the curved surface of the inner curved strip 31 and larger than a maximum inner diameter of the curved bottom 32c of the outer curved member 32.

The joint 30 is assembled to the guide strip 33 by placing the curved surfaces of the inner curved strip 31 and the guide strip 33 and the curved bottom 32c of the outer curved member 32 one upon another and further by inserting a bolt 34 through the through hole of the inner curved strip 31, an opening 33b of the guide strip 33 and a through hole of the curved bottom 32c of the outer curved member 32 and threadingly engaging the bolt 34 with the nut 35, so that the inner curved strip 31 and the outer curved member 32 are slidable along the guide strip 33 in the right-left direction and the up-down direction.

The joint 30 is thus constituted by assembling the inner curved strip 31, the guide strip 33 and the outer curved member 32 integrally to one another by the bolt 34 and nut 35. Small screw 36 are inserted through a pair of right and left through holes and a pair of upper and lower through holes formed in four corners of the flange 33a respectively, whereby the joint 30 is fixed to the front surface of the front panel 22 by the small screws 36.

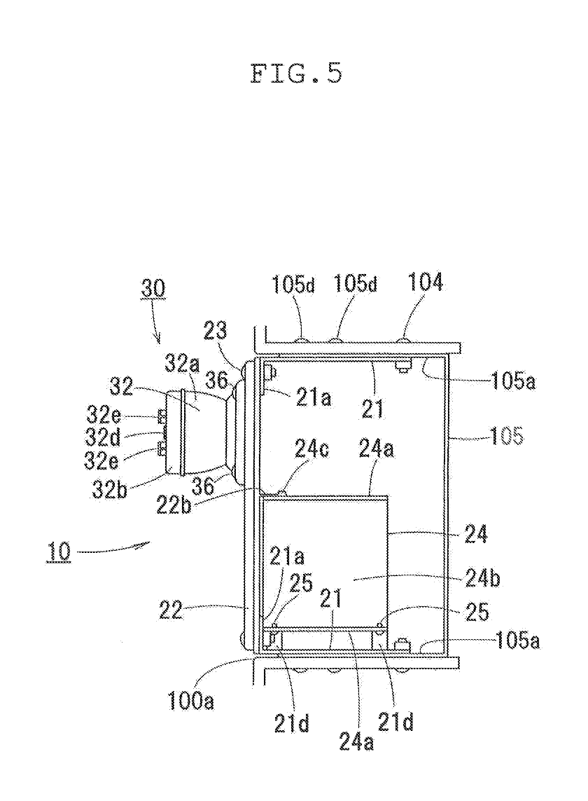

The dashboard bracket 10 constructed as described above is mounted in the car audio accommodating recess 100 of the dashboard 103 using a car audio mounting bracket 105 originally fixed in the accommodating recess 100, as shown in FIG. 5. The bracket 105 has a generally C-shaped section and includes a plurality of paired through holes 105b and positioning protrusions 105c formed in the right and left sides 105a thereof respectively. The through holes 105b are arranged and spaced from one another in the same manner as the screw holes 21b formed in the insertion plates 21, and the positioning protrusions 105c are arranged and spaced from one another in the same manner as the positioning small holes 21c.

The dashboard bracket 10 is mounted in the accommodating recess 100 by fitting the positioning protrusions 105c of the car audio mounting bracket 105 with the respective positioning small holes 21c of the insertion plates 21 and further by screwing the small screws 105d through the holes 105b into the screw holes 21b respectively.

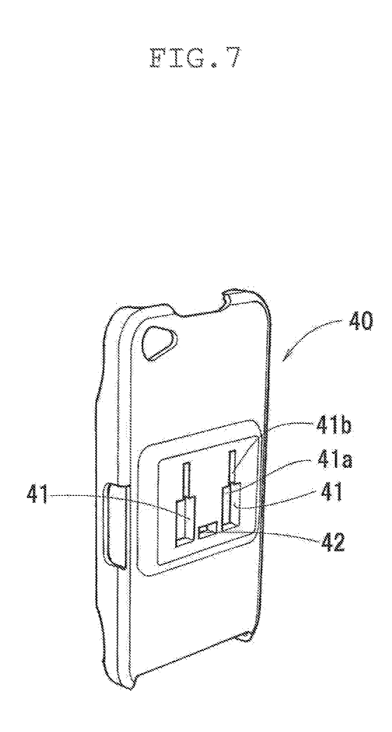

A holder 40 as shown in FIG. 7 is detachably attached to the joint 30 of the dashboard bracket 10 mounted in the accommodating recess 100 of the dashboard 103. The holder 40 has a rear surface formed with two first lock holes 41 and a second lock hole 42. The hook strips 32e formed on the cover 32b of the outer curved member 33 are to be engaged with the first lock holes 41 respectively, and the lock protrusion 32d is engaged with the second lock hole 42.

Each first lock hole 41 includes a wider rectangular hole 41a and a narrower rectangular hole 41b. The second lock hole 42 includes a short rectangular hole.

When the hook strips 32e are inserted through the respective rectangular holes 41a and the holder 40 is then slid, the hook strips 32e are engaged with the respective narrower rectangular holes 41b and the lock protrusion strip 32d is engaged with the second lock hole 42, whereby the holder 40 is detachably attached to the joint 30. A smartphone (not shown) is detachably attachable to the holder 40.

The dashboard bracket 10 according to the foregoing embodiment has the width and the height both of which are set according to the width and the height of the accommodating recess 100 formed in compliance with the double DIN size. Accordingly, the dashboard bracket 10 can be mounted in the accommodating recess 100 after the genuine car audio device 101 has been removed from the accommodating recess 100. Consequently, driver's view and air blast from the car air conditioner can be prevented from being blocked by the dashboard bracket 10.

Furthermore, since the bracket 105 is used which is originally mounted in the accommodating recess 100 for the purpose of installation of the genuine car audio device 101, the dashboard bracket 10 can be mounted in the accommodating recess 100 without machining or modifying the dashboard 103.

The front panel 22 is formed with the opening 22a, and the recess defining member is provided behind the opening 22a to house nongenuine equipment 106. Accordingly, the nongenuine equipment 106 such as the nongenuine car audio device or the portable music player can be housed in the accommodating recess 24 defined by the recess defining member as shown in FIG. 3. Consequently, the showing of the dashboard 103 can be prevented from being degraded by the nongenuine equipment.

Since the front opening 100a of the accommodating recess 100 is covered by the front panel 22, the front opening 100a is not exposed even after the genuine car audio device 101 has been removed from the accommodating recess 100. Consequently, the showing of the dashboard 103 can be prevented from being degraded.

Not only the nongenuine equipment 106 such as the nongenuine car audio device or the portable music player can be housed in the accommodating recess, but also the portable information terminal device such as a smartphone can be mounted on the front surface of the front panel 22 by the use of the holder 40. Furthermore, the direction of the portable information terminal is adjustable. Consequently, the usability of the dashboard bracket can be improved.

### Second Embodiment

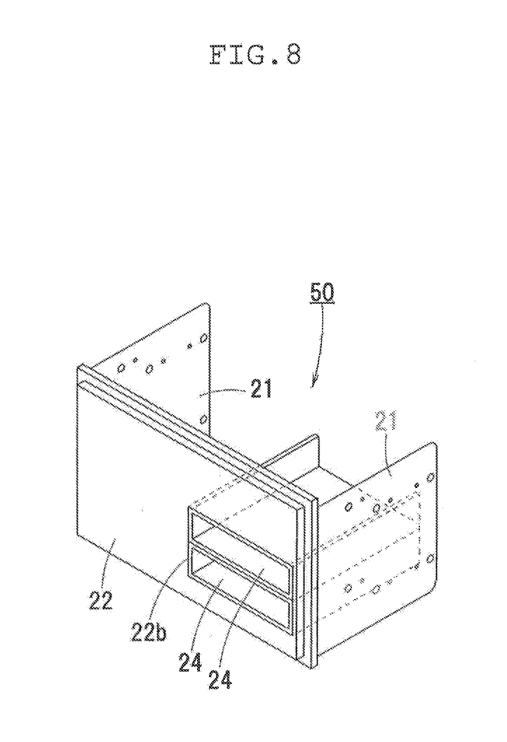

FIG. 8 illustrates a vehicle dashboard bracket 50 according to a second embodiment. The dashboard bracket 50 includes the front panel 22 with the front opening 22b having a width that is twice as large as the width of the front opening 22a of the dashboard bracket 10 according to the first embodiment. Two, that is, upper and lower accommodating recesses 24 are provided behind the front opening 22b, and the joint 30 is eliminated. The other construction of the dashboard bracket 50 is the same as that of the dashboard bracket 10 according to the first embodiment. Accordingly, identical components in the second embodiment are labeled by the same reference symbols as those in the first embodiment and the description of these components will be eliminated.

### Third Embodiment

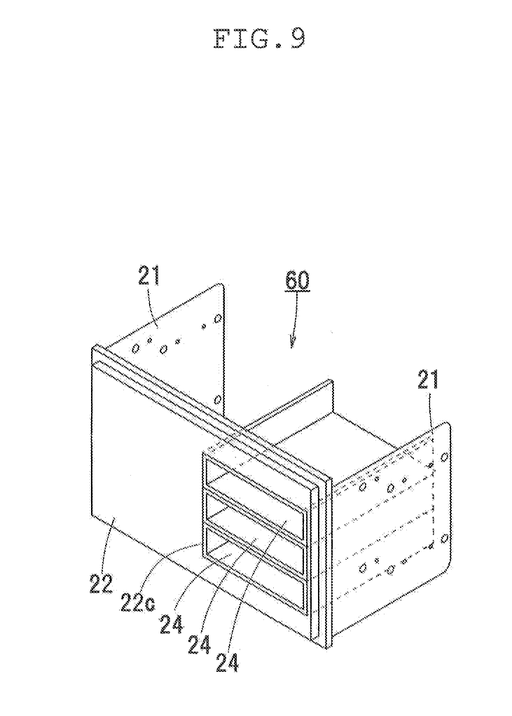

FIG. 9 illustrates a vehicle dashboard bracket 60 according to a third embodiment. The dashboard bracket 60 includes the front panel 22 with the front opening 22c having a width that is three times as large as the width of the front opening 22a of the dashboard bracket 10 according to the first embodiment, vertically arranged three-tier accommodating recesses 24 are provided behind the front opening 22b, and the joint 30 is eliminated. The other construction of the dashboard bracket 60 is the same as that of the dashboard bracket 10 according to the first embodiment. Accordingly, identical components in the third embodiment are labeled by the same reference symbols as those in the first embodiment and the description of these components will be eliminated.

### Fourth Embodiment

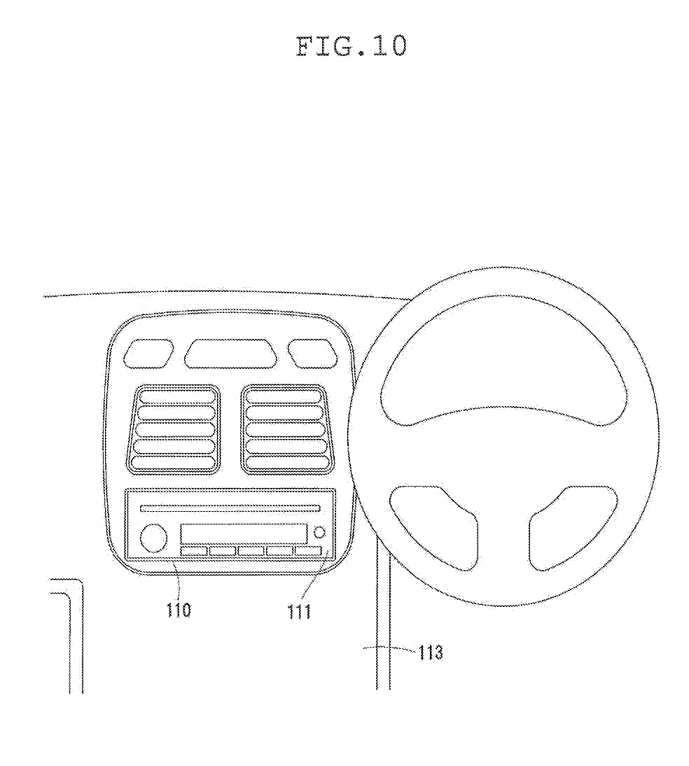

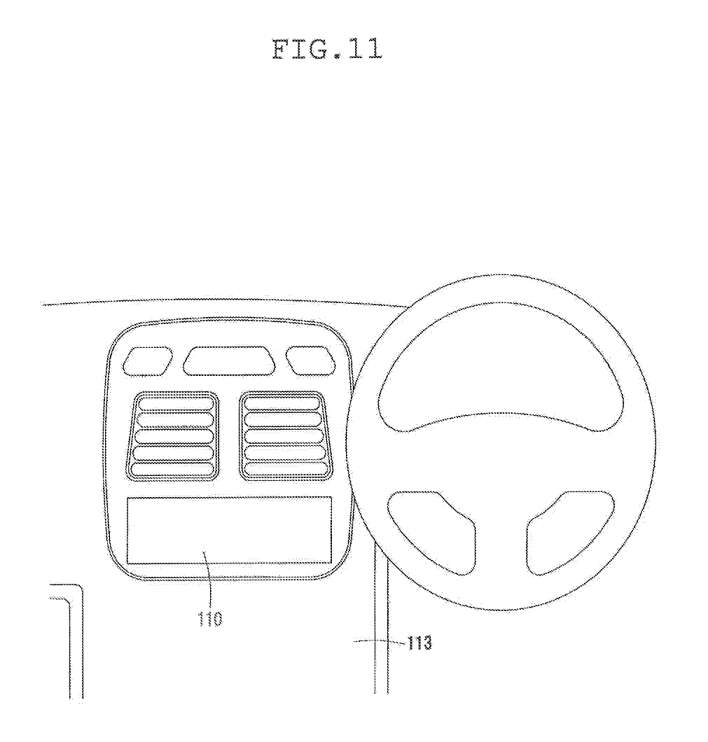

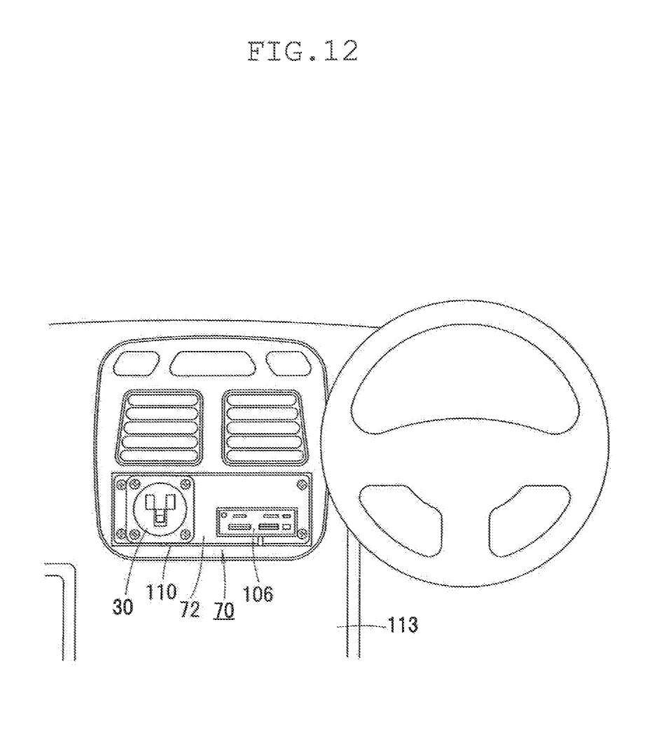

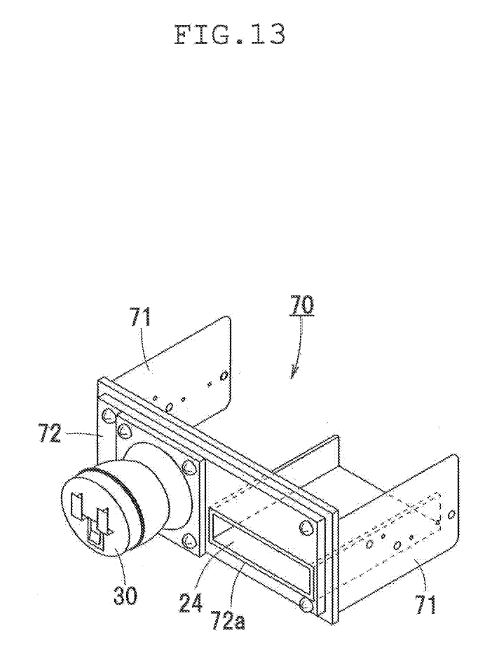

FIGS. 10 to 13 illustrate a dashboard bracket 70 according to a fourth embodiment. FIG. 10 shows a car dashboard 113 having a genuine car audio device 111 mounted in car audio accommodating recess 110 complying with the single DIN size. FIG. 11 shows the dashboard 113 with the genuine car audio device 111 having been removed from the accommodating recess 110. FIG. 12 shows the dashboard 113 having the dashboard bracket 70 mounted in the accommodating recess 110 complying with the single DIN size. FIG. 13 shows the dashboard bracket 70 according to the fourth embodiment.

The dashboard bracket 70 includes a pair of right and left insertion plates 71 and a front panel 72 which connects between the insertion plates 71 so that the bracket 70 is generally formed into a C-shape. Each insertion plate 71 has a plurality of screw holes 21b and a plurality of positioning small holes 21c paired with the screw holes 21b respectively.

The front panel 22 has a width and a height both of which are set so as to be capable of being housed in the single DIN size accommodating recess 110 and so as to cover a front opening 100a of the accommodating recess 110. The front panel 22 is formed with a horizontally long rectangular front opening 72a. The recess defining member is provided behind the opening 22a. The other construction of the dashboard bracket 70 is the same as that of the dashboard bracket 10 according to the first embodiment. Accordingly, identical components in the fourth embodiment are labeled by the same reference symbols as those in the first embodiment and the description of these components will be eliminated.

In the fourth embodiment, the dashboard bracket 70 can be housed in the accommodating recess 110 complying with the single DIN size and has the front panel 72 which is set to cover the front opening of the accommodating recess 110. Consequently, the dashboard bracket 70 can be mounted on the dashboard 113 having the recess of the single DIN size.

### Fifth Embodiment

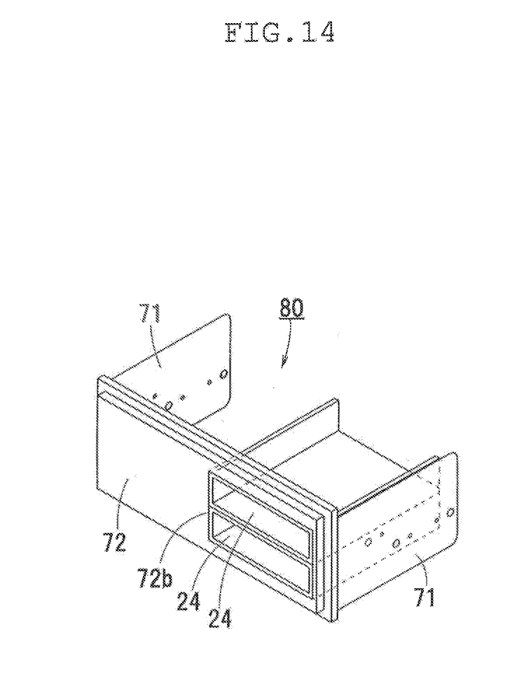

FIG. 14 illustrates a dashboard bracket 80 according to a fifth embodiment. The dashboard bracket 80 includes the front panel 72 with the front opening 72b having a width that is twice as large as the width of the front opening 72a of the dashboard bracket 10 according to the fourth embodiment. Upper and lower accommodating recesses 24 are mounted behind the front opening 72b, and the joint 30 is eliminated. The other construction of the dashboard bracket 80 is the same as that of the dashboard bracket 70 according to the fourth embodiment. Accordingly, identical components in the second embodiment are labeled by the same reference symbols as those in die fourth embodiment and the description of these components will be eliminated.

### Sixth Embodiment

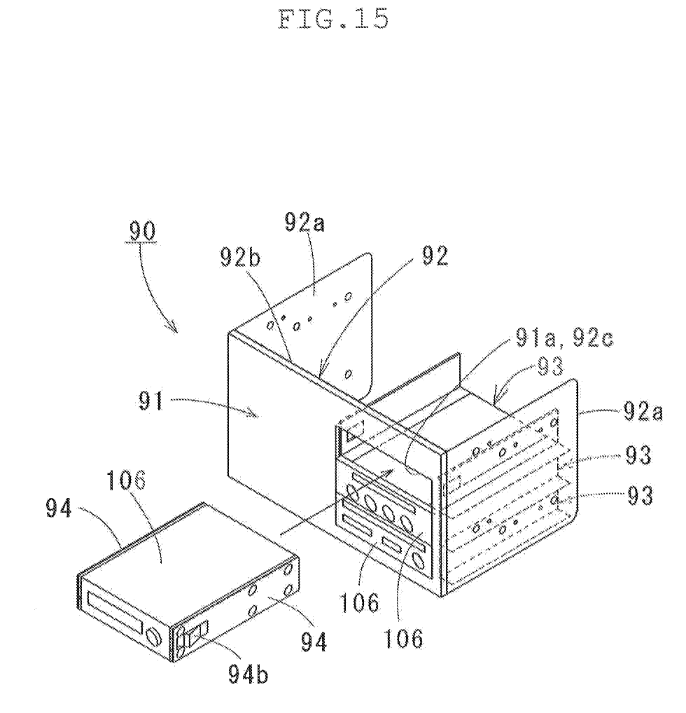

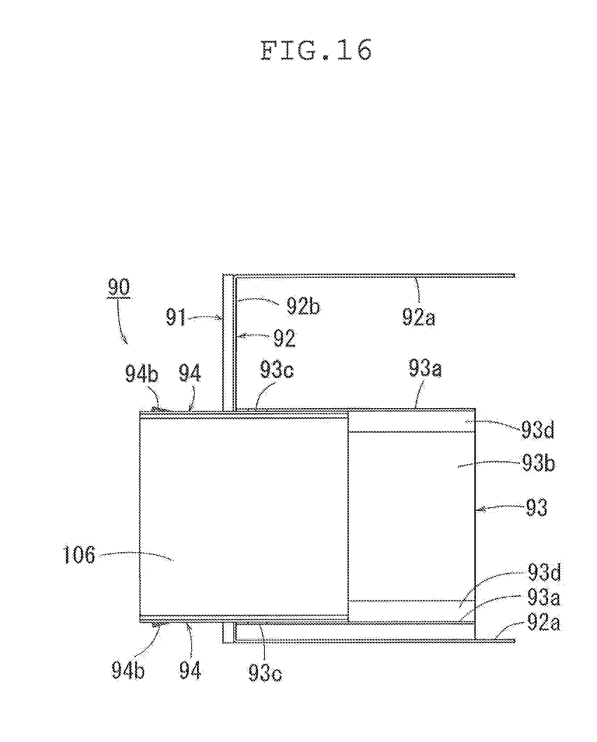

FIGS. 15 and 16 illustrate a dashboard bracket 90 according to a sixth embodiment. The dashboard bracket 90 includes a front panel 91 and an insertion frame 92 fixed to a rear surface of the front panel 91. The front panel 91 has a width and a height both of which are set so that the bracket 90 can be accommodated in the accommodating recess 100 of the double DIN size. The front panel 91 is formed with the opening 91a.

The insertion frame 92 includes a pair of right and left insertion plates 92a and a connecting plate 92b which connects the insertion plates 92a to each other. The connecting plate 92b is formed with an opening 92c having substantially the same size as the opening 91a of the front panel 91. Vertically stacked three-tier accommodating recesses 93 are defined by the recess defining members behind the opening 92c.

Each accommodating recess includes right and left sides 93a and a bottom 93b connecting the right and left sides 93a to each other and has a generally C-shaped section. The bottom 93b has a front end joined to the connecting plate 92b and a right end joined to the right insertion plate 92a. The accommodating recesses 93 have respective sides 93a having lock holes 93c located near the opening 92c respectively, A pair of slide rail plates 93d are fixed to the bottom 93b so as to be adjacent to the right and left sides 93a respectively, The insertion plate 92 is fixed to the rear surface of the front panel 91 by small screws so that the opening 92c thereof corresponds with the opening 91a of the front panel 91.

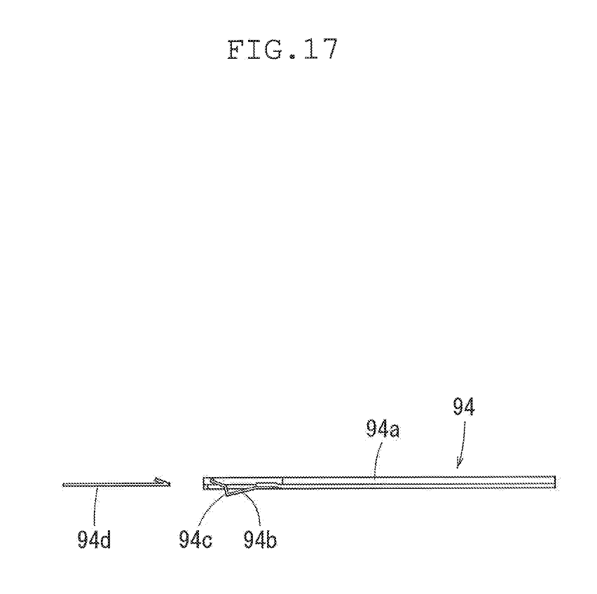

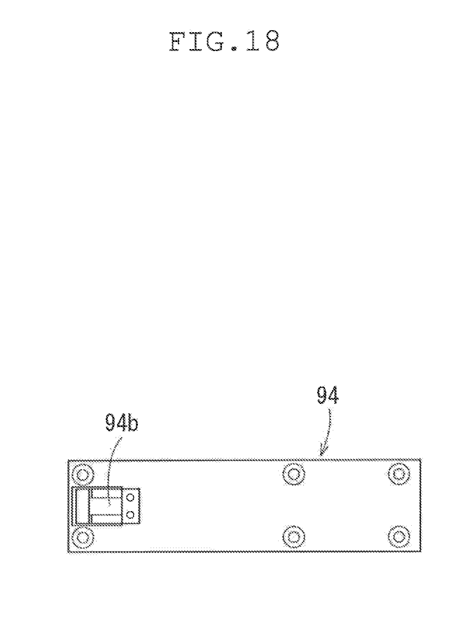

Nongenuine devices provided with lock plates 94 are mounted in the accommodating recesses 93 defined by the recess defining members respectively. The lock plates 94 include lock springs 94b mounted to base plates 94a respectively as shown in FIGS. 17 and 18. A leaf spring is used as each lock spring 94b and bent into a predetermined shape so that each lock spring 84b includes a middle part formed with a protrusion 94c. Each lock spring 94b has one end fixed to the base plate 94a. Each lock plate 94 is fixed to right and left sides of each nongenuine device 106 by countersunk screws.

The dashboard bracket 90 constructed as described above is mounted in the accommodating recess 100 by using the car audio mounting bracket 105 originally fixed in the accommodating recess 100 of the dashboard 103 by bolts 104 in the same manner as the dashboard bracket 10 according to the first embodiment.

The nongenuine devices 106 are inserted along the slide rail plates 93d. from the openings 91a and 92c of the accommodating recesses 93 of the brackets 90 mounted on the dashboard 103 respectively. When the nongenuine devices 106 are inserted until the front surfaces of the nongenuine devices 106 become substantially co-planar with the front panel 91, the protrusions 94c of the lock springs 94b are locked in the lock holes 93c, whereby the nongenuine devices 106 are mounted in the accommodating recesses, respectively. When the nongenuine devices 106 are to be removed from the accommodating recesses defined by the recess defining members 93, the release strips 94d are inserted along the lock plates 94 into the accommodating recesses 93, respectively. As a result, the protrusions 94c are inwardly flexed thereby to be disengaged from the lock holes 93c, whereupon the nongenuine devices 106 can be taken out of the accommodating recesses 93, respectively.

### Seventh Embodiment

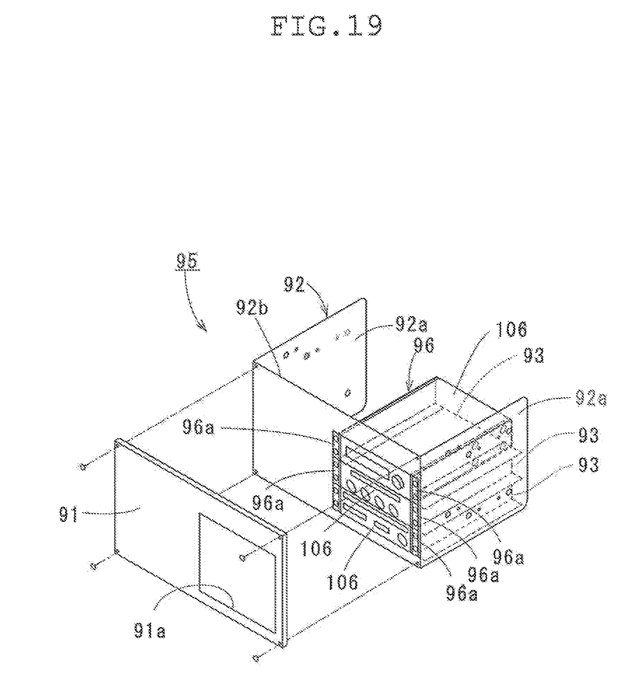

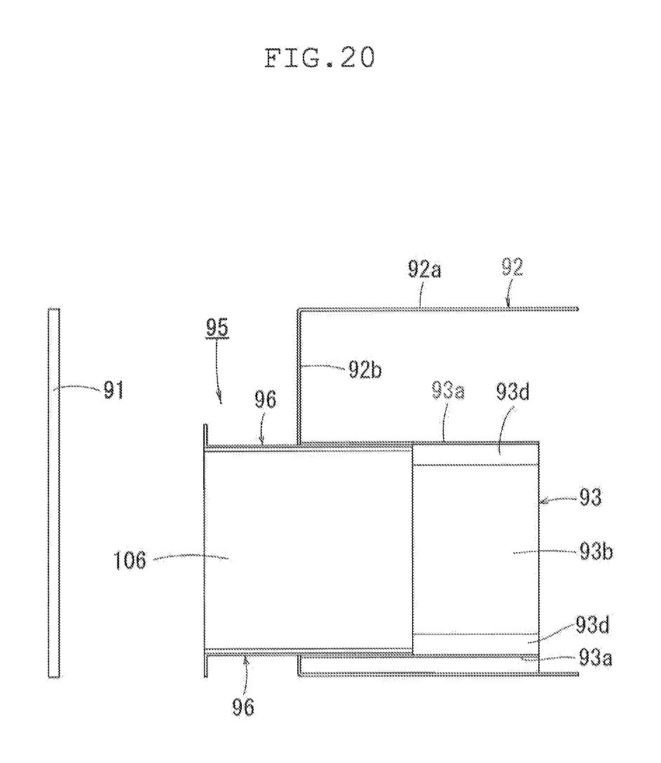

FIGS. 19 and 20 illustrate a dashboard bracket 95 according to a seventh embodiment. The nongenuine devices 106 to be mounted in the accommodating recesses 93 of the dashboard bracket 95 has right and left sides to which fittings 96 are fixed by countersunk screws, respectively. Each fitting 96 has one end having an outer bent portion 96a.

When a nongenuine device 106 is to be mounted in the accommodating recess 100 of the dashboard 103 using the dashboard bracket 95 according to the seventh embodiment, the insertion frame 92 is first attached to the accommodating recess 100. Thereafter, the genuine devices 106 to which the fittings 96 are fixed are inserted into the respective accommodating recesses 93. The outer bent portions 96a of the fittings 96 are then fixed to the connecting plate 92b of the insertion frame 92 by countersunk screws. The front panel 91 is subsequently fixed to the connecting plate 92b.

No lock holes 93c are formed in the right and left sides of the accommodating recesses 93 in the dashboard bracket 95 according to the seventh embodiment. The other construction of the dashboard bracket 95 is the same as the dashboard bracket 90 according to the sixth embodiment. Identical components or parts in the seventh embodiment are labeled by the same reference symbols as those in the sixth embodiment and description of these identical components and parts are eliminated.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. A dashboard bracket for a vehicle, comprising a front panel and a plurality of insertion plates located on right and left ends of the front panel or upper and lower ends of the front panel, the bracket having a width and a height set according to a width and a height of a first accommodating recess for accommodation of a car audio device so that the right and left insertion plates are secured to right and left wall surfaces of the first accommodating recess or so that the upper and lower insertion plates are secured to upper and left wall surfaces of the first accommodating recess, respectively, the first accommodating recess being defined in a dashboard of the vehicle and having a standardized width and a standardized height, wherein the front panel is formed with an opening and a second accommodating recess is defined by a recess defining member for accommodation of nongenuine equipment so as to be located behind the opening of the front panel.

2. The bracket according to claim 1, wherein the width and the height of the front panel are set so that a front opening of the first accommodating recess is substantially covered by the front panel.

3. The bracket according to claim 1, further comprising a joint fixed to a front surface of the front panel, wherein the joint has an end to which a holder holding a portable music player or an information terminal device is detachably attachable, the joint being capable of adjusting a direction of the holder in an up-down direction or a right-left direction.
